(19) United States
(12) Patent Application Publication
(10) Pub. No.: US 2010/0002935 A1
(43) Pub. Date: Jan. 7, 2010

(54) SYSTEM AND METHOD FOR DISPLAYING DIGITAL EDITIONS OF PERIODICALS AND PUBLICATIONS

(75) Inventor: Ric B. Richardson, Irvine, CA (US)

Correspondence Address: CONNOLLY BOVE LODGE & HUTZ LLP, P.O. BOX 2207, WILMINGTON, DE, 19899, US

(73) Assignee: zkimmer Inc, Beaverton, OR (US)

(21) Appl. No.: 12/247,165

(22) Filed: Oct. 7, 2008

Related U.S. Application Data
(60) Provisional application No. 61/077,873, filed on Jul. 3, 2008.

(51) Int. Cl. G06K 9/34

(52) U.S. Cl. 382/176

(57) ABSTRACT

Systems and methods are provided for displaying scanned information containing at least one of text and picture information of a document, wherein the document may include a plurality of scanned images. In one embodiment, the method may involve creating and utilizing at least one association of a given scanned image relative to one or more of the other scanned images of the document. The at least one association may define a relative location of the given scanned image with respect to one or more of the other scanned images.

### CROSS-REFERENCE TO RELATED APPLICATION(S)

This application claims priority pursuant to 35 U.S.C. §119(e) to U.S. Provisional Application No. 61/077,873, filed Jul. 3, 2008, entitled SYSTEM FOR DISPLAYING DIGITAL EDITIONS OF PICTORIAL PERIODICALS AND PUBLICATIONS, which application is specifically incorporated herein, in its entirety, by reference.

### BACKGROUND OF THE INVENTION

1. Field of the Invention

The present application relates generally to the display of graphics and text, and more specifically to systems and methods to enable the display of scanned images while preserving the layout format of the scanned images.

2. Description of the Related Art

Tiling methods or the like may be used for displaying large graphics files, such as, for example, digital maps, Tiling is a technique that involves breaking up data for such large graphics files into smaller segments of data that can be loaded as needed, rather than have the computing device attempt to load one large file in order to view the graphics file. For example, tiling may be used to produce tiles that correspond to the original high resolution version of the graphics file at different levels of magnification. For example, a tile of a graphics file that is 250 pixels by 250 pixels at maximum resolution may be displayed as a tile that is 125 pixels by 125 pixels at 50 percent magnification, thereby enabling more of the graphics file to be viewed from the computer screen.

Sometimes, however, the large graphics file may be generated from, or otherwise include, a plurality of scanned images, such as in the case of a periodical (e.g., book, newspaper, magazine, etc.) that is arranged in a double-page spread format or layout, such as the exemplary digital pictorial document 113 shown in FIG. 1. Accordingly, there is a need for an improved technique for displaying scanned information that preserves the relative association or spacing of the components images that make up the scanned information.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with for displaying scanned information containing at least one of text and picture information of a document, wherein the document may include a plurality of scanned images. In one approach, the technique may involve creating at least one association of a given scanned image relative to one or more of the other scanned images of the document. The at least one association may define a relative location of the given scanned image with respect to one or more of the other scanned images.

In related aspects, the technique may involve generating an image pane using the plurality of scanned images based at least in part on the at least one association of the given scanned image. The image pane may be displayed on a screen as a display image. The technique may also involve adjusting the display image on the screen to show a user-selected portion of the display image while maintaining the at least one association of the given scanned image. In further related aspects, the at least one association of the given scanned image may correspond to the user-selected portion. In yet further related aspects, the display image may comprise a predetermined number of scanned images. The predetermined number of scanned images is set by a user.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an exemplary pictorial document shown on a portable computing device and an on a computer monitor.

FIG. 2 illustrates an exemplary approach to displaying a pictorial document.

FIG. 3 is illustrates another exemplary approach to displaying a pictorial document.

FIG. 4A shows one embodiment for a method for displaying scanned information of a document.

FIG. 4B shows several sample aspects of the method shown in FIG. 4A.

FIG. 5A shows one embodiment for a system for displaying scanned information of a document.

FIG. 5B shows several sample aspects of the system shown in FIG. 5A.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

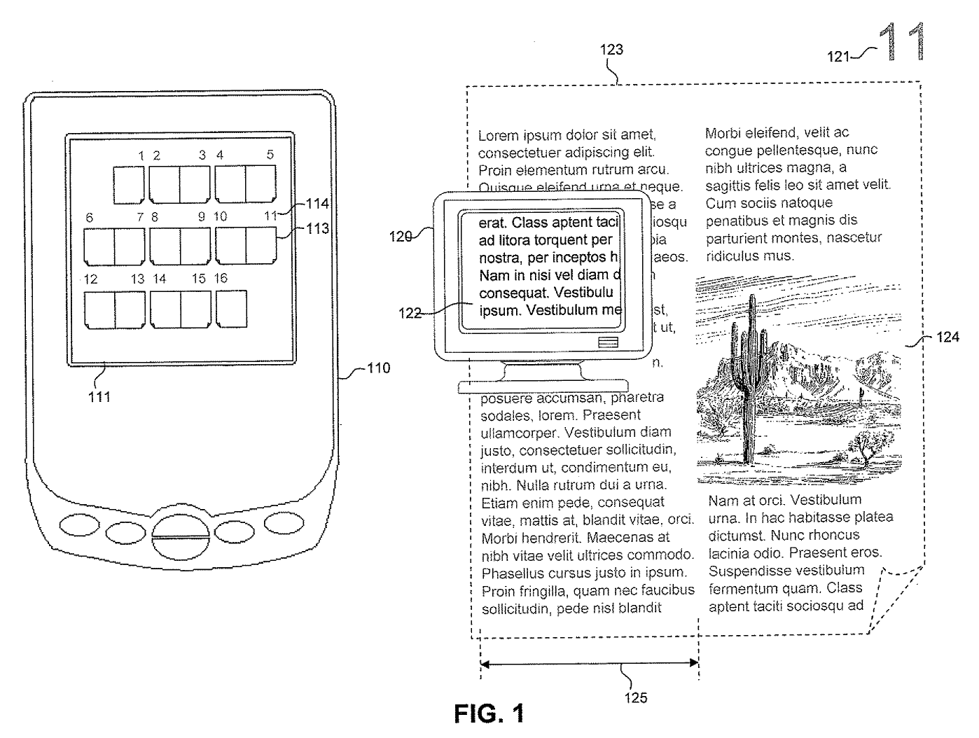

With reference to the embodiment of FIG. 1, there is depicted a digital pictorial document 113 displayed in low resolution on the screen 111 of a computing device 110, such as, for example, a Personal Digital Assistant (PDA) or other portable computing device or the like. The miniature representation of a page from a digitized pictorial document is depicted as an icon 113 on the screen 111 of the device 110. The screen 111 of the device 110 shows multiple pages from the digital pictorial document displayed in double pages spreads and also features page numbers 114 (e.g., pages 1 through 16) that enable easy navigation amongst pages as the user moves from page to page at a desired level of magnification.

FIG. 1 also shows the same document 113 displayed in high resolution format 123 on the screen 122 of a personal computer monitor 120 or the like. In high resolution, the same document that is displayed as a small graphic icon 113 on the device 110 can be displayed as a document so large that a graphic representation of the digital pictorial document can fill the screen 122 or a personal computer monitor 120 with less than a column 125 of the text of one page of data from a digital pictorial document. In the higher resolution format 123, the display of the digital pictorial document is able to show details of graphic page elements, such as, for example, pictures 124 and fine typography. The embodiment of FIG. 1 utilizes a graphical page identification system that shows the page number 121 next to the page 123 as it is displayed.

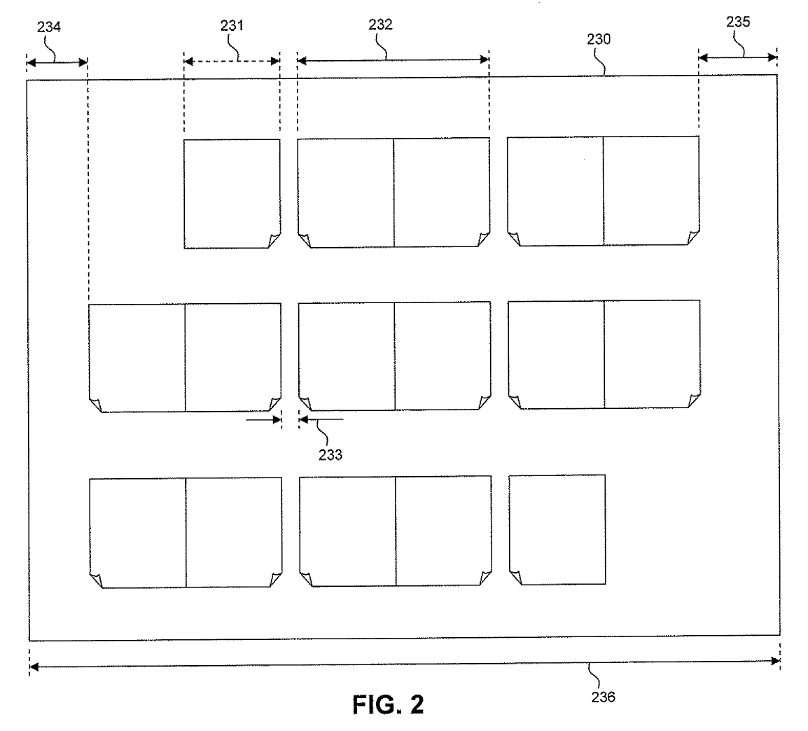

With reference to FIG. 2, there is shown an example of how a pictorial digital document 230 can be displayed using aspects of the embodiments described herein, which may involve calculating a width 236 of the combined pages 231 of the document. This example uses a total of sixteen pages arrayed in three rows of up to three double page spreads 232 or six pages total. The total width of the digital pictorial document 230 in this embodiment is the sum of the left page margin 234 measured in pixels, three times the width of a double page spread 232 of two pages from the digital pictorial document, the right page margin 235, and two times the gap 233 between the double-page spreads.

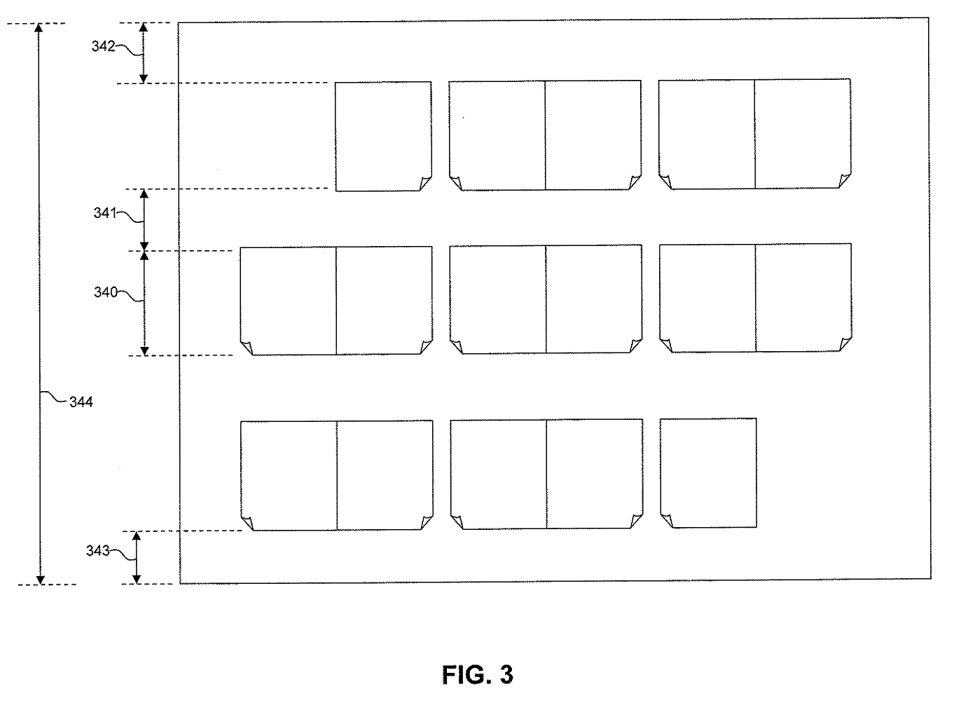

With reference to FIG. 3, there is illustrated an example of how a pictorial digital document can be displayed using aspects of the embodiments described herein, which may involve calculating the total height 344 of the combined pages 340 of the document. This example uses a total of sixteen pages arrayed in three rows of up to three double page spreads or six pages total. The total height of the digital pictorial document 344 in this embodiment is the sum of the top page margin 342 measured in pixels, three times the height of a page 340 of a page from the digital pictorial document representing the three rows of pages in this embodiment the bottom page margin 343, and two times the gap 341 between the page rows.

It is noted that aspects of the techniques described herein may involve representing a pictorial document that is displayed to the user of a computing device in a variety of resolutions or zoom levels that allows easy viewing of parts of a page or multiple pages on a wide range of computing and display devices. In the example embodiment of FIG. 1, the representation of the document at its lowest resolution may display three double-page spreads across the screen 111 of a small viewing device 110, such as, for example, a cell phone, PDA, or the like. On a device like device 110 that may have a screen resolution of three hundred and sixty pixels by three hundred and sixty pixels, the six pages 113 of pictorial document data representing three double page spreads may represent less than sixty pixels width per page including a small amount of space between the double page spreads.

At maximum resolution 123, the magnification of the pictorial document may display one column 125 of a two column formatted digital pictorial document so that the column typography fills the width of a high resolution personal computer screen 122. In the case of the display of a digital pictorial document in high resolution, the total width of a single page in the document 131 may be forty-eight hundred pixels. At such a magnification, a graphic representation of a double-page spread 132 may be ninety-six hundred pixels in width.

In related aspects, the display techniques described may utilize a tiling method or the like to represent the pictorial document pages in both the maximum and minimum resolutions using a predefined number of magnification or zoom levels. In the example embodiment of FIG. 1, twenty levels of magnification may be used where the users have the option of clicking on a specific point or location of the document to either zoom in or out of the document. The technique may further involve going to and displaying the corresponding location of a tile at a different resolution.

If the lowest desired resolution representation of a page 113 is sixty pixels in width and the maximum desired resolution representation is forty-eight hundred pixels in width 123, and the number of levels of magnification is twenty, then the width of each page at each level of magnification may be the sum of forty-eight hundred minus sixty divided by twenty times the level of magnification. For example the width of a page at level ten may be forty-eight hundred minus sixty divided by twenty and times ten, or twenty-three hundred and seventy pixels.

The techniques described herein may utilize tiling methods, such as, for example those used for map data, to produce full screen representations of each page or alternatively row of pages so that the page data can be easily retrieved from storage and displayed. For example, a user clicking on the top centre of page one of a pictorial document in the described examples lowest resolution 111 would be clicking on a pixel thirty pixels to the right of the top left of a page that is sixty pixels wide. If the user chooses to zoom in or magnify the same location on their screen by going to magnification level ten, then the corresponding point displayed to the user is a pixel two hundred and thirty seven pixels from the right of the top left most part of the pictorial document.

At the highest resolution 123, the computer may display an image of the pictorial document centered on the pixel that is twenty-four hundred pixels to the right of the top left most part of the page. The height of each page displayed using the invention may be calculated from the width-to-height ratio of the original pictorial document. For example if the original digital pictorial document is forty-eight hundred pixels wide and sixty hundred pixels high then the width-to-height ratio is four to five. Conversely the same page 113 as represented at minimum resolution of sixty pixels wide will be seventy-five pixels in height.

In the example embodiment of FIG. 2, the width of the pictorial display area 136 of three double page spreads 132 may be three times ninety-six hundred pixels, plus two page spaces 133 of six hundred pixels each, and plus the margin space of six hundred pixels on the left 134 and right 135 sides of the page giving the page a total width 136 of thirty-one thousand and two hundred pixels.

In the example embodiment of FIG. 3, the height of the pictorial display area 344 of a pictorial document containing a total sixteen pages comprising a front page and two double page spreads in row one, a second row containing three double-page spreads 340 and a third row comprising two double page spreads and a single page on the last row. The height of the total graphic display area for the digital pictorial document 344 may be calculated with the sum of amount to six hundred pixels for the top margin 342, sixty hundred pixels times three rows 340, two times six hundred pixels to allow for space 341 between the rows of pages, and six hundred pixels for a bottom of the display margin 343 coming to a total height for the pictorial display area 344 of twenty thousand four hundred pixels.

In related aspects, the height of the pictorial display may be increased to accommodate digital pictorial documents with more pages. In further related aspects, the display techniques described herein may utilize more or fewer levels of magnification to allow more or fewer options for viewing the pictorial document data. In still further related aspects, the display techniques described herein may display more than one double page spread of pictorial page data per row in the digital pictorial document display area, and/or up to one hundred or more double page spreads in the same row.

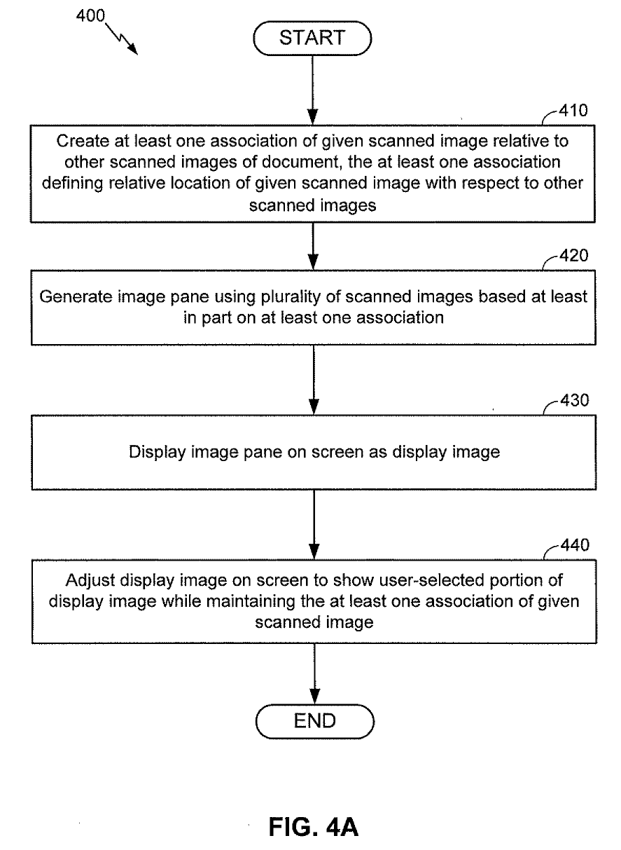

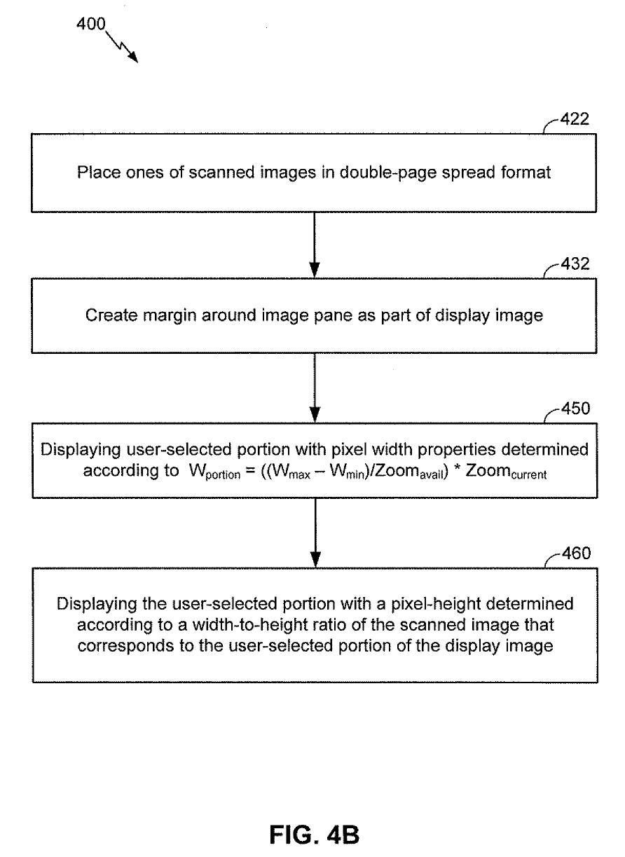

In accordance with one or more aspects of the embodiments described herein, there are provided a method for displaying scanned information containing at least one of text and picture information of a document, wherein the document may include a plurality of scanned images. With reference to the flow chart shown in FIG. 4A, there is provided a method 400 that may involve creating at least one association of a given scanned image relative to one or more of the other scanned images of the document (step 410). The at least one association may define a relative location of the given scanned image with respect to one or more of the other scanned images.

At step 420, the method 400 may involve generating an image pane using the plurality of scanned images based at least in part on the at least one association of the given scanned image. The image pane may be displayed on a screen as a display image (step 430). The method 400 may also involve adjusting the display image on the screen to show a user-selected portion of the display image while maintaining the at least one association of the given scanned image (step 440). In related aspects, the at least one association of the given scanned image may correspond to the user-selected portion. In further related aspects, the display image may comprise a predetermined number of scanned images. The predetermined number of scanned images is set by a user.

With reference to FIG. 4B, in one embodiment, step 430 may include step 432 of creating a margin around the image pane as part of the display image, wherein size of the margin is based at least in part on the predetermined number of scanned images. In another embodiment, step 420 may include step 422 of placing ones of the scanned images in a double-page spread format. The double-page spread format may comprise a plurality of double-page portions, each portion having two scanned images enjoined together using their associations with respect to each other.

In yet another embodiment, the method 400 may include step 450 of displaying the user-selected portion with pixel width properties determined according to an equation: Wₚₒᵣₜᵢₒₙ=((Wₘₐₓ−Wₘᵢₙ)/Zoomₐᵥₐᵢₗ)*Zoom_{current}. It is noted that Wₚₒᵣₜᵢₒₙ may comprise the pixel width of the selected portion being displayed, that Wₘₐₓ may comprise a maximum pixel width of a portion that can be displayed, that Wₘᵢₙ may comprise a minimum pixel width of a portion that can be displayed, that Zoomₐᵥₐᵢₗ may comprise a number of available zoom levels, and that Zoom_{current} may comprise a current selected zoom level. In the alternative, or in addition, the method 400 may include the step 460 of displaying the user-selected portion with a pixel-height determined according to a width-to-height ratio of the scanned image that corresponds to the user-selected portion of the display image.

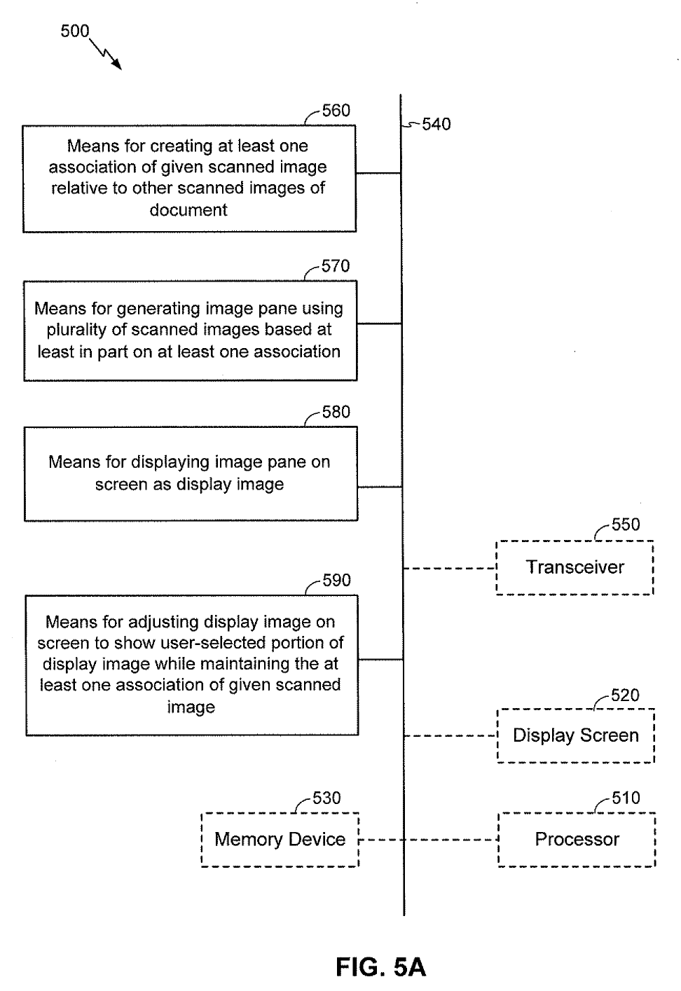

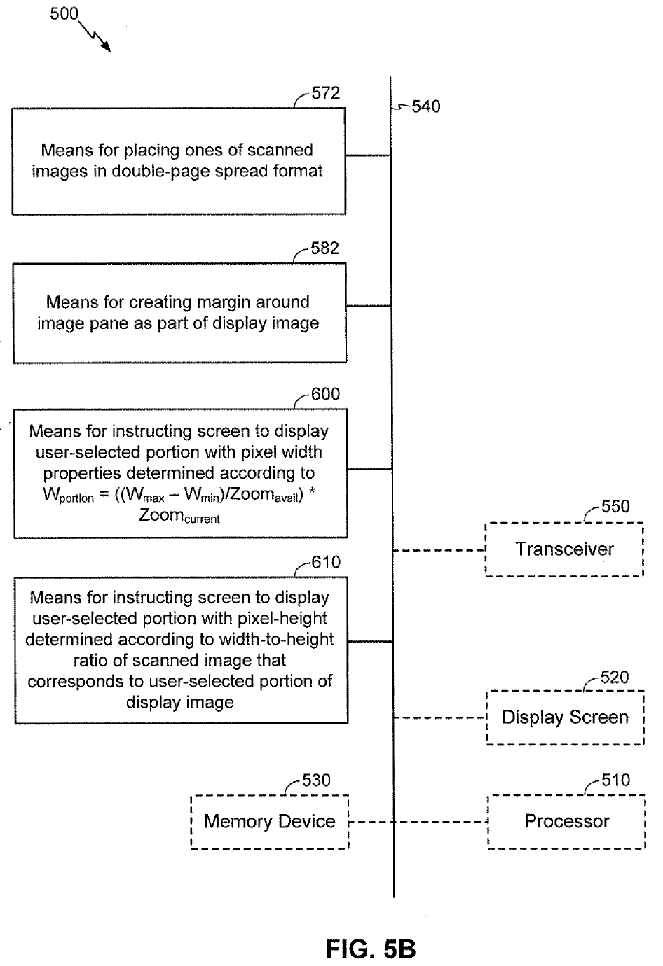

In accordance with one or more aspects of the embodiments described herein, there are provided a system for displaying scanned information containing at least one of text and picture information of a document. The document may include a plurality of scanned images. With reference to FIG. 5A, there is provided an exemplary system 500 that includes: at least one processor 510; a display screen 520 in operative communication with the at least one processor 510; and a memory 530 in operative communication with the at least one processor 510. The memory 530 may comprise a computer readable medium or memory device/module. The components of the system 500 may communicate via a bus 540 or similar communication coupling.

The memory 530 may comprise executable code for the at least one processor 510 to: (a) create at least one association of a given scanned image relative to one or more of the other scanned images of the document, the at least one association defining a relative location of the given scanned image with respect to one or more of the other scanned images; and (b) generate an image pane using the plurality of scanned images based at least in part on the at least one association of the given scanned image. The memory 530 may further comprise executable code for the at least one processor 510 to: (d) display the image pane on the screen 520 as a display image; and (e) adjust the display image on the screen 520 to show a user-selected portion of the display image while maintaining the at least one association of the given scanned image.

In related aspects, the at least one association of the given scanned image may correspond to the user-selected portion. In further related aspects, the display image may comprise a predetermined number of scanned images. The predetermined number of scanned images is set by a user.

With reference to FIG. 5B, in one embodiment, the at least one processor 510 creates a margin around the image pane as part of the display image, wherein size of the margin is based at least in part on the predetermined number of scanned images. In the alterative, or in addition, the system 500 may comprise a means 582 for creating a margin around the image pane as part of the display image.

In another embodiment, the at least one processor 510 places ones of the scanned images in a double-page spread format. In the alterative, or in addition, the system 500 may comprise a means 572 for placing ones of the scanned images in a double-page spread format. The double-page spread format may comprise a plurality of double-page portions, each portion having two scanned images enjoined together using their associations with respect to each other.

In yet another embodiment, the at least one processor 510 instructs the screen 520 to display the user-selected portion with pixel width properties determined according to an equation: Wₚₒᵣₜᵢₒₙ=((Wₘₐₓ−Wₘᵢₙ)*Zoomₐᵥₐᵢₗ)*Zoom_{current}, which is described in further detail above. In the alterative, or in addition, the system 500 may comprise a means 600 for instructing the screen 520 to display the user-selected portion with pixel width properties determined according to the above equation.

In still another embodiment, the at least one processor 510 instructs the screen to display 520 the user-selected portion with a pixel-height determined according to a width-to-height ratio of the scanned image that corresponds to the user-selected portion of the display image. In the alterative, or in addition, the system 500 may comprise a means 610 for instructing the screen to display the user-selected portion with a pixel-height determined according to a width-to-height ratio of the scanned image that corresponds to the user-selected portion of the display image.

It is noted that the system 500 may also include an optional transceiver 550 or the like operatively coupled to one or more of the other components of the system 500. A stand alone receiver and/or stand alone transmitter may be used in lieu of or in conjunction with the transceiver 550.

It is further noted that the system 500 may optionally include: a means 560 for creating at least one association of given scanned image relative to other scanned images of document; a means for 570 generating image pane using plurality of scanned images based at least in part on at least one association; a means 580 for displaying image pane on screen as display image; and/or a means 590 for adjusting display image on screen to show user-selected portion of display image while maintaining the at least one association of given scanned image. The at least one processor 510, in such case, may be in operative communication with the means 560, 570, 580, and 590 via a bus 540 or similar communication coupling. The at least one processor 510 may effect initiation and scheduling of the processes or functions performed by the means 560, 570, 580, and 590, and any components thereof.

While the present invention has been illustrated and described with particularity in terms of preferred embodiments, it should be understood that no limitation of the scope of the invention is intended thereby. Features of any of the foregoing methods and devices may be substituted or added into the others, as will be apparent to those of skill in the art. It should also be understood that variations of the particular embodiments described herein incorporating the principles of the present invention will occur to those of ordinary skill in the art and yet be within the scope of the invention.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

It is understood that the specific order or hierarchy of steps in the processes disclosed herein in an example of exemplary approaches. Based upon design preferences, it is understood that the specific order or hierarchy of steps in the processes may be rearranged while remaining within the scope of the present disclosure The accompanying method claims present elements of the various steps in sample order, and are not meant to be limited to the specific order or hierarchy presented.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

What is claimed is:

1. A method for displaying scanned information containing at least one of text and picture information of a document, the document including a plurality of scanned images, comprising:
creating at least one association of a given scanned image relative to one or more of the other scanned images of the document, the at least one association defining a relative location of the given scanned image with respect to one or more of the other scanned images;
generating an image pane using the plurality of scanned images based at least in part on the at least one association of the given scanned image;
displaying the image pane on a screen as a display image; and
adjusting the display image on the screen to show a user-selected portion of the display image while maintaining the at least one association of the given scanned image.

2. The method of claim 1, wherein the display image comprises a predetermined number of scanned images.

3. The method of claim 2, wherein the predetermined number of scanned images is set by a user.

4. The method of claim 2, wherein displaying the image pane comprises creating a margin around the image pane as part of the display image, wherein size of the margin is based at least in part on the predetermined number of scanned images.

5. The method of claim 1, wherein generating the image pane comprises placing ones of the scanned images in a double-page spread format.

6. The method of claim 5, wherein the double-page spread format comprises a plurality of double-page portions, each portion having two scanned images enjoined together using their associations with respect to each other.

7. The method of claim 1, further comprising:
displaying the user-selected portion with pixel width properties determined according to an equation:
Wₚₒᵣₜᵢₒₙ=((Wₘₐₓ−Wₘᵢₙ)/Zoomₐᵥₐᵢₗ)*Zoom_{current},
wherein Wₚₒᵣₜᵢₒₙ comprises the pixel width of the selected portion being displayed, Wₘₐₓ comprises a maximum pixel width of a portion that can be displayed, Wₘᵢₙ comprises a minimum pixel width of a portion that can be displayed, Zoomₐᵥₐᵢₗ comprises a number of available zoom levels, and Zoom_{current} comprises a current selected zoom level.

8. The method of claim 1, further comprising displaying the user-selected portion with a pixel-height determined according to a width-to-height ratio of the scanned image that corresponds to the user-selected portion of the display image.

9. A system displaying scanned information containing at least one of text and picture information of a document, the document including a plurality of scanned images, comprising:
at least one processor;
a display screen in operative communication with the at least one processor; and
a memory in operative communication with the at least one processor and comprising executable code for the at least one processor to:
create at least one association of a given scanned image relative to one or more of the other scanned images of the document, the at least one association defining a relative location of the given scanned image with respect to one or more of the other scanned images;
generate an image pane using the plurality of scanned images based at least in part on the at least one association of the given scanned image;
display the image pane on the screen as a display image; and
adjust the display image on the screen to show a user-selected portion of the display image while maintaining the at least one association of the given scanned image.

10. The system of claim 9, wherein the display image comprises a predetermined number of scanned images.

11. The system of claim 10 wherein the predetermined number of scanned images is set by a user.

12. The system of claim 10, wherein the at least one processor is adapted to create a margin around the image pane as part of the display image, wherein size of the margin is based at least in part on the predetermined number of scanned images.

13. The system of claim 9, wherein the at least one processor is adapted to place ones of the scanned images in a double-page spread format.

14. The system of claim 13, wherein the double-page spread format comprises a plurality of double-page portions, each portion having two scanned images enjoined together using their associations with respect to each other.

15. The system of claim 9, wherein:
the at least one processor is adapted to instruct the screen to display the user-selected portion with pixel width properties determined according to an equation:
Wₚₒᵣₜᵢₒₙ−(Wₘₐₓ−Wₘᵢₙ)/Zoomₐᵥₐᵢₗ)*Zoom_{current};
Wₚₒᵣₜᵢₒₙ comprises the pixel width of the selected portion being displayed;
Wₘₐₓ comprises a maximum pixel width of a portion that can be displayed;
Wₘᵢₙ comprises a minimum pixel width of a portion that can be displayed;
Zoomₐᵥₐᵢₗ comprises a number of available zoom levels; and
Zoom_{current} comprises a current selected zoom level.

16. The system of claim 9, wherein the at least one processor is adapted to instruct the screen to display the user-selected portion with a pixel-height determined according to a width-to-height ratio of the scanned image that corresponds to the user-selected portion of the display image.

17. A system displaying scanned information containing at least one of text and picture information of a document, the document including a plurality of scanned images, comprising:
means for creating at least one association of a given scanned image relative to one or more of the other scanned images of the document, the at least one association defining a relative location of the given scanned image with respect to one or more of the other scanned images;
means for generating an image pane using the plurality of scanned images based at least in part on the at least one association of the given scanned image;
means for displaying the image pane on a screen as a display image; and
means for adjusting the display image on the screen to show a user-selected portion of the display image while maintaining the at least one association of the given scanned image.

18. The system of claim 17, wherein the display image comprises a predetermined number of scanned images.

19. The system of claim 18, wherein the predetermined number of scanned images is set by a user.

20. The system of claim 18, wherein the means for displaying comprises means for creating a margin around the image pane as part of the display image, wherein size of the margin is based at least in part on the predetermined number of scanned images.

21. The system of claim 17, wherein the means for generating comprises means for formatting that places ones of the scanned images in a double-page spread format.

22. The system of claim 21, wherein the double-page spread format comprises a plurality of double-page portions, each portion having two scanned images enjoined together using their associations with respect to each other.

23. The system of claim 17, wherein:
the means for displaying comprises means for instructing the screen to display the user-selected portion with pixel width properties determined according to an equation:
Wₚₒᵣₜᵢₒₙ=((Wₘₐₓ−Wₘᵢₙ)/Zoomₐᵥₐᵢₗ)*Zoom_{current};
Wₚₒᵣₜᵢₒₙ comprises the pixel width of the selected portion being displayed;
Wₘₐₓ comprises a maximum pixel width of a portion that can be displayed;
Wₘᵢₙ comprises a minimum pixel width of a portion that can be displayed;
Zoomₐᵥₐᵢₗ comprises a number of available zoom levels; and
Zoom_{current} comprises a current selected zoom level.

24. The system of claim 17, wherein the means for displaying comprises means for instructing the screen to display the user-selected portion with a pixel-height determined according to a width-to-height ratio of the scanned image that corresponds to the user-selected portion of the display image.

25. A computer program product, comprising:
a computer-readable medium comprising:
code for causing a computer to create at least one association of a given scanned image relative to one or more of the other scanned images of the document, the at least one association defining a relative location of the given scanned image with respect to one or more of the other scanned images;
code for causing the computer to generate an image pane using the plurality of scanned images based at least in part on the at least one association of the given scanned image;
code for causing the computer to display the image pane on the screen as a display image; and
code for causing the computer to adjust the display image on the screen to show a user-selected portion of the display image while maintaining the at least one association of the given scanned image corresponding to the user-selected portion.
